(19) United States
(12) Patent Application Publication
(10) Pub. No.: US 2020/0298760 A1
(43) Pub. Date: Sep. 24, 2020

(54) VEHICLE REARVIEW MIRROR

(71) Applicant: FU HWA MIRROR CO., LTD., Changhua County (TW)

(72) Inventor: PIN-SHU HUANG, CHANGHUA COUNTY (TW)

(21) Appl. No.: 16/814,264

(22) Filed: Mar. 10, 2020

(30) Foreign Application Priority Data
Mar. 22, 2019 (TW) 108110112

(51) Int. Cl. B60R 1/08; F21V 8/00; B60R 1/12

(52) U.S. Cl. CPC B60R 1/08; G02B 6/0036; B60Q 9/008; B60R 1/1207; G02B 6/0041

(57) ABSTRACT

A vehicle rearview mirror includes a reflector having a light-transmissive pattern, and a light emitting module including a case, a light source and a light guide. The light guide is disposed in the case and has an illuminating surface and a prism surface opposite to the illuminating surface for total reflection. The light guide is provided on a side thereof with an incidence surface. The light source is disposed in the case and faces the incidence surface in a way that the light emitted by the light source enters the light guide through the incidence surface and reflected by the prism surface to the illuminating surface which faces the light-transmissive pattern, thereby showing the light-transmissive pattern.

### BACKGROUND OF THE INVENTION

### 1. Field of the Invention

The present invention is a rearview mirror for general vehicles.

### 2. Description of the Related Art

A blind spot monitoring system detects objects around the body of a vehicle by a detector installed on the body of the vehicle. When the detector detects an object such as another vehicle, the driver is alerted through vision, hearing or vibration, which aids the driver to compensate the visual blind spots around the vehicle to ensure driving safety.

In the conventional art, for example, U.S. Pat. No. 9,227,557 B2 describes a vehicle rearview mirror with an indicate function. Referring to FIG. 2 of the aforementioned patent, it is noted that the mirror surface 20 is provided with a light-transmissive zone 21 and an indicator device 30 is disposed behind the mirror surface 20. The indicator device 30 includes a reflection base 31 and light emitting members 32. The light emitting members 32 face a reflecting surface 311 of the reflection base 31, so that the light emitted by the light emitting members 32 is reflected by the reflecting surface 311 to the light-transmissive zone 21 to indicate the user.

However, the conventional indicator device 30 of the rearview mirror usually uses LEDS (light emitting diodes) as the light emitting members 32, and the LEDS are linear light sources only applicable to a small-area light-transmissive zone 21 as described in the above-mentioned patent, but inapplicable to a light-transmissive zone with a large area or a customized pattern, thereby limited in usage and still improvable.

### SUMMARY OF THE INVENTION

It is one of the objectives of the present invention to make an improvement aimed at the defects of the conventional rearview mirrors so as to provide an improved vehicle rearview mirror which can show a customized pattern with a larger area.

A vehicle rearview mirror according to an embodiment of the present invention is provided to include a reflector and a light emitting module. The reflector has a back surface provided with a light-transmissive pattern for alerting or instructing the driver. The light emitting module is disposed behind the reflector and includes a case, a light source and a light guide. The light guide is disposed in the case and has an illuminating surface and a prism surface provided opposite to the illuminating surface for total reflection. The light guide is provided on a side thereof with an incidence surface. The light source is disposed in the case and faces the incidence surface in a way that light emitted by the light source enters the light guide through the incidence surface and the aforementioned prism surface reflects the light emitted by the light source to the illuminating surface which faces the light-transmissive pattern, thereby showing the light-transmissive pattern.

Through the structural design of the above-described rearview mirror, the light emitted by the light source is affected by the light guide to be uniformly projected from the illuminating surface and evenly distributed over the entire illuminating surface, so that the light emitting module is capable of emitting a large-area light. In other words, the whole light emitting module can be regarded as a surface light source, thereby applicable to various light-transmissive patterns with large area and customized design.

In one of the aspects, the rearview mirror may be a rear-view mirror inside the vehicle or a side-view mirror outside the vehicle.

In another aspect, the prism surface is a sawtooth surface.

In another aspect, the light source includes an LED array and the light source is fixed in the case.

In another aspect, the illuminating surface is a flat plane.

In another aspect, the light guide includes light diffusing agent therein.

In another aspect, for making the light emitting module stably fixed to the reflector and face the light-transmissive pattern, the light emitting module may be directly connected to the back surface of the reflector. In an alternative, the case of the light emitting module may be provided on the outer surface thereof with a bump in a way that the light emitting module can be directly connected to the back surface of the reflector by the bump.

### BRIEF DESCRIPTION OF THE DRAWINGS

The detailed structure, features and assembly or usage manners of the vehicle rearview mirror of the present invention will be specified in a following embodiment, but it should be understood that the following embodiment and the accompanying drawings are given for illustration only, not limitative of the claimed scope of the present invention, and wherein:

FIG. 1 is a perspective view of a vehicle rearview mirror of the embodiment;

FIG. 2 is approximately a side view of FIG. 1, but doesn't show a mirror mount of the rearview mirror;

FIG. 3 is an exploded perspective view of a light emitting module of the embodiment;

FIG. 4 is a sectional view of the light emitting module of the embodiment;

FIG. 5 is a perspective view of a light guide of the light emitting module of the embodiment; and

FIG. 6 is a block diagram showing the operation of a blind spot monitoring system of the embodiment.

### DETAILED DESCRIPTION OF THE INVENTION

The technology and features of the present invention will be specified in a following embodiment and the appendix drawings. The directional terms mentioned in the contents of the specification, such as ‘above’, ‘below’, ‘inside’, ‘outside’, ‘top’ and ‘bottom’, are just for illustrative description on the basis of normal usage direction, not intended to limit the claimed scope.

For specifying the technical features of the present invention, a following embodiment and the appendix drawings are given here under. This embodiment takes a side-view mirror outside the vehicle as an illustrative example of the rearview mirror of the present invention.

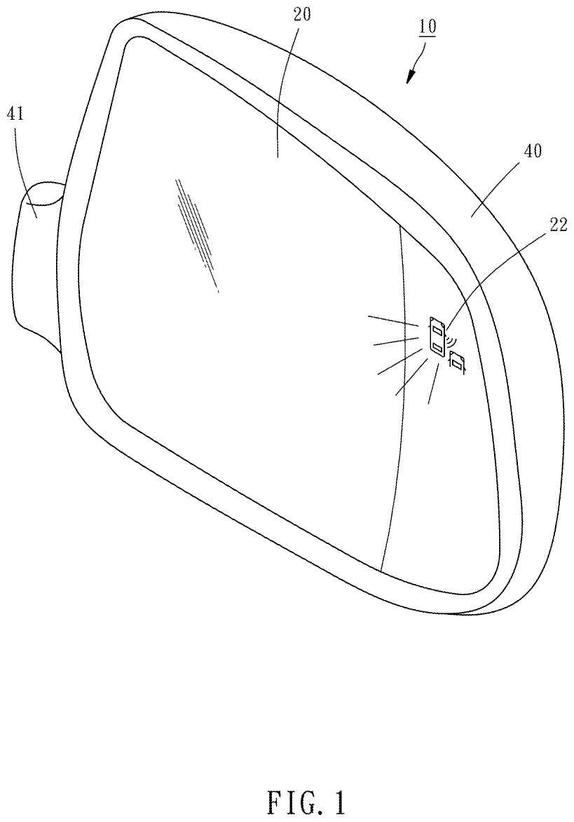

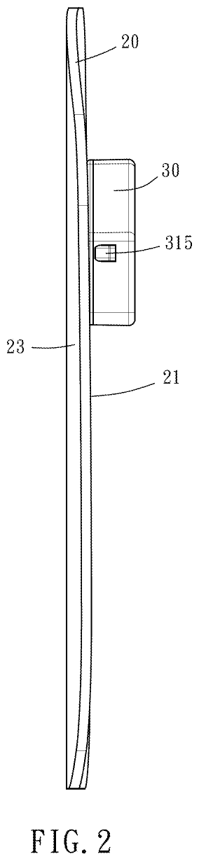

As shown in FIGS. 1-2, a rearview mirror 10 includes a reflector 20, a light emitting module 30 and a mirror mount 40, wherein the reflector 20 is a mirror mounted to the mirror mount 40 and the light emitting module 30 is disposed inside the mirror mount 40.

The reflector 20 is adapted to show objects located around the vehicle and provided on a back surface 21 thereof with a cladding layer of aluminum or chromium for reflecting function. The cladding layer is usually very thin, thereby it is not illustrated in FIG. 2. Besides, the cladding layer is engraved with a light-transmissive pattern 22 by laser engraving, which is provided at a proper position on the back of the reflector 20, such as the position relatively far away from a connecting member 41 of the mirror mount 40 as shown in this embodiment, so that light can be transmitted through the light-transmissive pattern 22 from the back surface 21 of the reflector 20 to the front surface 23 of the reflector 20.

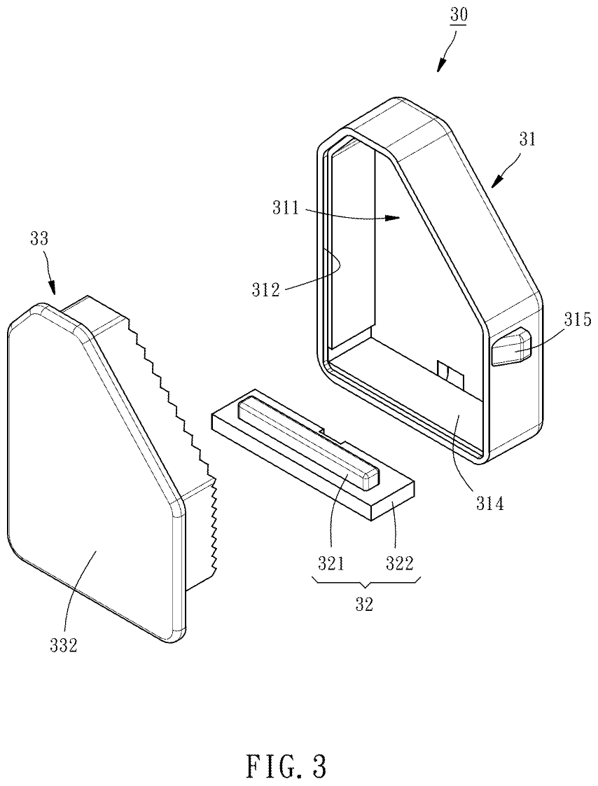

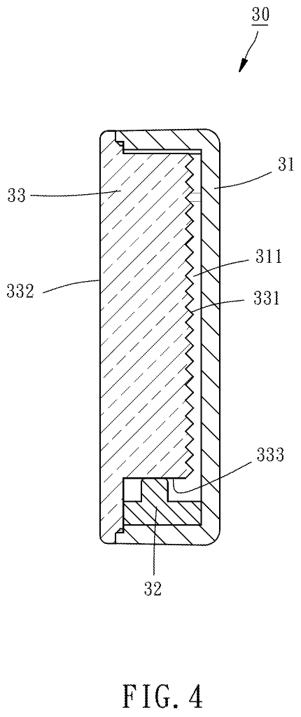

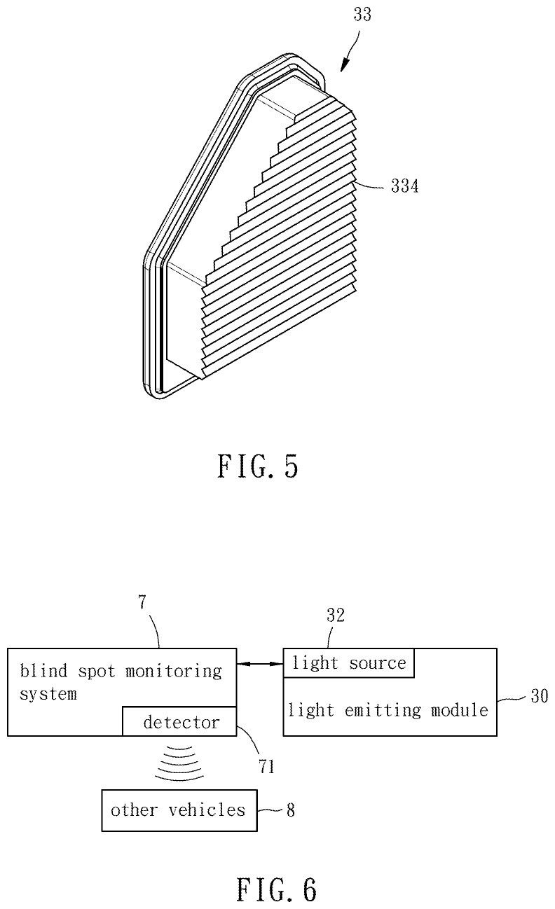

Referring to FIGS. 2-5, the light emitting module 30 includes a case 31, a light source 32 and a light guide 33. The case 31 is hollow-shaped and has an accommodating room 311, an opening 312 and an installation surface 314. The accommodating room 311 communicates with the outside of the light emitting module through the opening 312. The case 31 is made of plastic and provided on the inner wall thereof with a smooth metal layer by coating for reflecting function. Besides, the case 31 is provided on the outer surface thereof with two bumps 315 in a way that the light emitting module 30 can be disposed behind the reflector 20 by the bumps 315. Only one of the bumps 315 is shown in FIGS. 2 and 3. As shown in FIGS. 3-5, the light guide 33 is made of acrylic and includes light diffusing agent therein for increasing the light diffusivity of the light guide 33. The light guide 33 is fixed to the case 31 by ultrasonic welding (or gluing) and covers the opening 312. The light guide 33 has a prism surface 331 and an illuminating surface 332 which are provided opposite to each other. Besides, the light guide 30 is provided on a side thereof with an incidence surface 333. The illuminating surface 332 is a flat plane. The prism surface 331 is a sawtooth surface including a plurality of triangle sections 334 as shown in FIG. 5. The triangle sections 334 extend transversely and are arranged equidistantly. The incidence surface 333 is a flat plane facing the installation surface 314. The light source 32 in this embodiment uses LED, which includes an LED array 321 fixed on a substrate 322 by integrated circuit packaging. The light source 32 is fixed on the installation surface 314 in the accommodating room 311. The LED array 321 can be controlled to emit light in a way that the light emitted by the light source 32 enters the light guide 33 through the incidence surface 333 and reflected or totally reflected to the illuminating surface 332 by the prism surface 331, so that a large-area light is uniformly projected from the illuminating surface 332 to illuminate and show the light-transmissive pattern 22, thereby enabling the driver to see the illuminated pattern 22 from the outside of the rearview mirror 10.

Referring to FIG. 6, through the structural design of the above-described rearview mirror 10, when a detector 71 of a blind spot monitoring system 7 of the vehicle detects another vehicle 8 (or a pedestrian) around the vehicle, the blind spot monitoring system 7 activates the light source 32 to emit light, so that the light emitted by the light source 32 is affected by the light guide 33 to be projected uniformly as a large-area light to the light-transmissive pattern 22, thereby showing the light-transmissive pattern 22 to alert the driver for ensuring the driving safety. Through the effect of the light guide 33 broadening the area of the light, the entire light emitting module 30 can be regarded as a surface light source, thereby applicable to various light-transmissive patterns 22 with large area and customized design.

The above description is only an instanced embodiment of the present invention, and all equivalent changes and modifications made in accordance with the following claims should be included within the scope of the present invention.

What is claimed is:

1. A vehicle rearview mirror comprising:
a reflector having a back surface provided with a light-transmissive pattern; and
a light emitting module being disposed behind the reflector, the light emitting module comprising a case, a light source and a light guide, the light guide being disposed in the case and having an illuminating surface and a prism surface opposite to the illuminating surface for total reflection, the light guide being provided on a side thereof with an incidence surface, the light source being disposed in the case and facing the incidence surface in a way that light emitted by the light source enters the light guide through the incidence surface and the prism surface reflects the light emitted by the light source to the illuminating surface;
wherein the illuminating surface faces the light-transmissive pattern.

2. The vehicle rearview mirror as claimed in claim 1, wherein the prism surface is a sawtooth surface.

3. The vehicle rearview mirror as claimed in claim 1, wherein the light source includes an LED array and the light source is fixed in the case.

4. The vehicle rearview mirror as claimed in claim 1, wherein the illuminating surface is a flat plane.

5. The vehicle rearview mirror as claimed in claim 1, wherein the light guide comprises light diffusing agent therein.

6. The vehicle rearview mirror as claimed in claim 1, wherein the light emitting module is directly connected to the back surface of the reflector.

7. The vehicle rearview mirror as claimed in claim 1, wherein the case is provided on an outer surface thereof with a bump; the light emitting module is directly connected to the back surface of the reflector by the bump.
